(19) United States
(12) Patent Application Publication
(10) Pub. No.: US 2006/0066759 A1
(43) Pub. Date: Mar. 30, 2006

(54) Automatic frequency tuning system

(75) Inventors: Makoto Ikuma, Kyoto (JP); Yasuo Oba, Shiga (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/230,894

(22) Filed: Sep. 21, 2005

(30) Foreign Application Priority Data
Sep. 29, 2004 (JP) 2004-284442

(51) Int. Cl. H04N 5/50; H04B 1/18

(52) U.S. Cl. 348/735; 455/182.2

(57) ABSTRACT

An automatic frequency tuning system according to the present invention includes an antenna, a tuner circuit, a video SAW filter, a video intermediate frequency amplifier, a video detector, a video amplifier, a video PLL circuit, an AFT control circuit, a microcomputer and a memory. In addition to the above members, the automatic frequency tuning system further includes a reference PLL circuit for reducing variation in a free running frequency of a video voltage controlled oscillator, a comparator for determining a magnitude relationship between a received video frequency and a standard video frequency, a mixer for mixing an output signal of the video control frequency and an output signal of a reference voltage controlled oscillator and retrieving sum and difference signals for frequencies of the outputs, and a mixer low pass filter for supplying only a frequency difference signal to a subsequent stage.

### BACKGROUND OF THE INVENTION

The present invention relates to an automatic frequency tuning (AFT) system, and more particularly relates to an apparatus including a digital AFT control circuit for controlling an oscillation frequency of a local oscillator in an AFT system. For example, the present invention relates to the field of video reproduction apparatus including a television receiver and a television tuner.

In recent years, to accurately receive video signals and audio signals, a digital AFT control circuit has been used in a television receiver.

An AFT control circuit is a circuit for measuring a video intermediate frequency input to a video intermediate frequency signal processing circuit (VIF circuit), transmitting a difference between the video intermediate frequency and a standard video intermediate frequency to a local oscillator in a previous stage via a microcomputer, and automatically correcting the video intermediate frequency to the standard frequency. The video intermediate frequency is set to be a constant level at all the time. For example, the video intermediate frequency is constantly set to be 58.75 MHz in Japan and 45.75 in the United States.

As a frequent problem, in a CATV system that converts television broadcasts and relays them by cable, and like systems, a video carrier frequency itself sometimes differs from a reference frequency and a video intermediate frequency differs from a standard frequency.

In an analog AFT control circuit, a video intermediate frequency is measured by analog processing. Thus, the analog AFT control circuit is easily influenced by a power supply voltage, an ambient temperature and variation in circuit elements such as a transistor, a capacitance and a resistance. Therefore, to suppress a frequency resolution of the analog AFT to a generally required level, i.e., about 10 kHz, the circuit configuration of the analog AFT control circuit becomes complicated. Also, fine tuning is performed at the final step of testing ICs, thus resulting in increase in cost.

However, in a digital AFT control circuit, a received video intermediate frequency is digitally counted. Thus, the digital AFT control circuit is not influenced by a power supply source, an ambient temperature of an IC and circuit elements. Therefore, although depending on the size of the digital AFT control circuit, a resolution for measurement of a frequency can be made to be about 10 kHz in a relatively simple manner.

In the known digital AFT control circuit, a received video intermediate frequency is directly counted, a result of the count is transmitted to a local oscillator in a previous stage and automatic tuning of the video intermediate frequency is performed. However, a frequency resolution of about 10 kHz is required for counting a video intermediate frequency of 58.75 MHz. That is, a frequency counter with very high accuracy is required. If a video intermediate frequency is not input to a frequency divider and is directly counted, a good frequency resolution can be obtained. However, in such a case, a frequency counter circuit of a very large size is required, thus resulting in increase in cost. On the other hand, assume that a video intermediate frequency is counted via a frequency divider. Although depending on a frequency division ratio, the circuit size of a required frequency counter becomes smaller, but a frequency resolution becomes poor.

As a matter of course, there have been market demands of increasing in accuracy in automatic frequency tuning and providing ICs at a reasonable price. However, with known methods, it has been difficult to meet the two demands at the same time.

Hereinafter, the operation of a known digital AFT control circuit will be described with reference to FIG. 11. FIG. 11 is a circuit diagram illustrating the configuration of a known automatic frequency tuning system.

As shown in FIG. 11, a system for controlling the known digital AFT control circuit mainly includes an antenna 10, a tuner circuit 100 for selecting a signal at a desired channel frequency from received television high frequency signals and converting the selected signal into a video intermediate frequency signal, and a video intermediate frequency signal processing circuit 101 for detecting a video signal from the video frequency signal.

Next, the operation of the digital AFT control circuit of FIG. 11 will be described. First, in the antenna 10, when television high frequency signals in the UHF band or the VHF band are received, in a high-frequency amplifier 11, a signal at a desired channel frequency is selected from the television high-frequency signals and the selected signal is amplified. In a first mixer circuit 12, a signal from the high-frequency amplifier 11 and a signal from a local oscillator 13 are mixed and converted into a video intermediate signal. For example, in Japan, the video intermediate frequency signal has a frequency of 58.75 MHz.

A video SAW filter (surface-acoustic-wave) 14 has characteristics of a band-pass filter for a video intermediate frequency signal. Accordingly, in the video SAW filter 14, only a video intermediate frequency signal is discriminated and passes through the video SAW filter 14. The video intermediate frequency signal is amplified by a video intermediate frequency amplifier 20 and then is applied to a video detector 21. An output signal of the video intermediate frequency amplifier 20 is also applied to a video PLL circuit 102 including a video phase detector 25, a video low pass filter (LPF) 27, a video voltage controlled oscillator (VCO) 28 and a phase shifter 26.

In the video PLL circuit 102, after a phase of a signal output from the video voltage controlled oscillator 28 is shifted by the phase shifter 26, a resultant signal (signal a) is input to the video phase detector 25. Moreover, an output signal (signal b) of the video intermediate frequency amplifier 20 is also input to the video phase detector 25. In the video phase detector 25, a frequency difference (phase difference) between the signal a and the signal b is detected and the frequency difference is input to the video low pass filter 27. The frequency difference is smoothed in the video low pass filter 27 to be a frequency control voltage and is fed back to the video voltage controlled oscillator 28. Then, the video PLL circuit 102 is operated so that the frequency of the video voltage controlled oscillator 28 becomes a video intermediate frequency and the phase difference between the signal a and the signal b becomes 90 degrees.

On the other hand, in the phase shifter 26, a signal c having a phase shifted from the phase of the signal a by 90 degrees is generated and the signal c is input to the video detector 21. The phase of the signal c is equal to the phase of an output signal from the video intermediate frequency amplifier 20. Therefore, the video detector 21 can synchronously detect a video signal and output the video signal.

The output of the video voltage controlled oscillator 28 synchronized with the video intermediate frequency is divided by a 1/L frequency divider 90 and is input to an AFT control circuit 91 having the function of digital automatic frequency tuning. The video intermediate frequency is directly counted by a frequency counter (not shown) provided in the AFT control circuit 91. Instead of the output signal of the video voltage controlled oscillator 28, an output signal of the phase shifter 26 (the signal a or the signal c in FIG. 11) may be counted.

Moreover, the frequency count is performed with reference to an accurate reference frequency, usually using an oscillation frequency of a crystal oscillator XtalOSC 33. The frequency of XtalOSC 33 is, for example, 3.58 MHz or 4.00 MHz. Frequency accuracy in this case is several kHz, which is considered relatively high.

An output signal of the digital AFT control circuit 91 is a digital signal indicative of a frequency difference between a standard video intermediate frequency and a received video intermediate frequency. The specification of the output signal differs among set manufacturers and tuner package manufacturers. To discriminate such frequency differences, thresholds, for example, 0 kHz, ±50 kHz, ±100 kHz and ±150 kHz for setting several stages are provided. Also, a frequency resolution of about 10 kHz is required for discriminating frequency differences. Considering that the video intermediate frequency is 58.75 MHz in Japan, a very high frequency resolution is required. A digital signal that is an output signal of the AFT control circuit 91 is fed back to the local oscillator 13 via the microcomputer 15. Thus, even when a different frequency is received, the digital AFT control circuit is operated so that the video intermediate frequency is automatically tuned and becomes constantly at a standard level, i.e., 58.75 MHz.

As has been described, in the known digital AFT control circuit, the video intermediate signal frequency output from the first mixer circuit 12 is controlled so as to be kept constant by an output signal of the digital AFT control circuit 91 of FIG. 11.

In the known configuration, the output signal of the video voltage controlled oscillator 28 synchronized with a received video intermediate frequency is frequency-divided by the 1/L frequency divider 90 and the frequency of the output signal is counted by the digital AFT control circuit 91. In this case, as described above, a system which counts the AFT the video intermediate frequency of 58.75 MHz with a resolution of about 10 kHz is required. If a frequency division ratio of the 1/L frequency divider 90 is increased, a greater frequency resolution is obtained, but the circuit size of the frequency counter becomes very large. This results in cost increase. In contrast, if the ratio of frequency division by the 1/L frequency divider 90 is reduced, although the circuit size of the frequency counter can be reduced, the frequency resolution becomes poor.

As has been described, improvement of frequency resolution and reduction in circuit size of the frequency counter are mutually contradictory. Therefore, in known methods, the frequency division ratio of the 1/L frequency divider 90 is set so that the frequency resolution becomes a minimum necessary level, i.e., about 10 kHz. Thus, the circuit size is reduced to as a small size as possible, thereby avoiding increase in cost. However, even in such a case, there is still a problem of not capable of sufficiently reducing the circuit size.

### SUMMARY OF THE INVENTION

It is an object of the present invention to devise means for largely reducing a circuit size without reducing a frequency resolution, thereby providing an automatic frequency tuning system which allows both of improvement of performance and reduction at the same time.

An automatic frequency tuning system according to a first embodiment of the present invention includes: a first phase synchronous circuit including a first voltage controlled oscillator circuit, a first phase detector circuit for comparing a phase of an output signal of the first voltage controlled oscillator circuit to a phase of a received video intermediate frequency signal, and a first low pass filter for smoothing an output of the phase detector circuit and feeding back a first frequency control voltage to the first voltage controlled oscillator circuit; a second voltage controlled oscillator circuit synchronized with a frequency received from a highly stable frequency source externally located and oscillating at a standard video intermediate frequency; a mixer for outputting a mixture component obtained by mixing a frequency output from the first voltage controlled oscillator circuit and a frequency output from the second voltage controlled oscillator circuit; a second low pass filter for passing only a low frequency component extracted from the mixture component; a comparator for determining a magnitude relationship between the received video intermediate frequency which is an oscillation frequency of the first voltage controlled oscillator circuit and the standard video intermediate frequency; and an AFT control circuit for receiving an output signal of the comparator and an output signal of the second low pass filter, counting a frequency difference between the standard video intermediate frequency and the received video intermediate frequency, determining a polarity of the received video intermediate frequency based on the output signal of the comparator, and outputting a digital signal corresponding to the frequency difference.

In the automatic frequency tuning system of the first embodiment of the present invention, the oscillation frequency of the first control oscillator circuit and an oscillation frequency of the second voltage controlled oscillator circuit may be set to be substantially the same. Note that “substantially the same frequency” means that a frequency difference between the first voltage controlled oscillator circuit and the second voltage controlled oscillator circuit is a very small value which is negligible, compared to a difference with a video intermediate frequency.

In the automatic frequency tuning system of the first embodiment of the present invention, the first frequency control voltage may be proportional to the received video intermediate frequency, and the comparator may compare the first frequency control voltage to a reference voltage which has been previously set, thereby determining a magnitude relationship between the received video intermediate frequency and the standard video intermediate frequency.

In the automatic frequency tuning system of the first embodiment of the present invention, the reference voltage in the comparator may be previously set so as to be equal to the first frequency control voltage obtained when the received video intermediate frequency is the standard video intermediate frequency.

In the automatic frequency tuning system of the first embodiment of the present invention, the comparator may have a hysteresis characteristic with respect to the first frequency control voltage.

In the automatic frequency tuning system of the first embodiment of the present invention, the second voltage controlled oscillator circuit may have substantially the same configuration as a configuration of the first voltage controlled oscillator, the automatic frequency tuning system may further comprise a second phase synchronous circuit including a first frequency divider for frequency-dividing an output signal of the second voltage controlled oscillator circuit, a second frequency divider for frequency-dividing an output signal of the highly stable frequency source externally located, a second phase detector circuit for comparing a phase of an output signal from the first frequency divider to a phase of an output signal from the second frequency divider, and a third low pass filter for smoothing an output signal of the second phase detector circuit and feeding back a signal corresponding to a second frequency control voltage to the second voltage controlled oscillator circuit, and the second frequency control voltage may be also supplied to the first voltage controlled oscillator circuit, so that a free running frequency of the first voltage controlled oscillator circuit is automatically tuned so as to be equal to the standard video intermediate frequency.

The automatic frequency tuning system of the first embodiment of the present invention may further include a local oscillator circuit for receiving an output signal from the AFT control circuit and the local oscillator circuit may generate a high-frequency signal for frequency-converting a received signal which is a television signal received from an antenna into a standard video intermediate frequency.

An automatic frequency tuning system according to a second embodiment of the present invention includes: a first phase synchronous circuit including a first voltage controlled oscillator circuit, a first phase detector circuit for comparing a phase of an output signal of the first voltage controlled oscillator circuit to a phase of a received video intermediate frequency signal, and a first low pass filter for smoothing an output of the phase detector circuit and feeding back a first frequency control voltage to the first voltage controlled oscillator circuit; a second voltage controlled oscillator circuit synchronized with a frequency received from a highly stable frequency source externally located and oscillating at a standard video intermediate frequency; a mixer for outputting a mixture component obtained by mixing a frequency output from the first voltage controlled oscillator circuit and a frequency output from the second voltage controlled oscillator circuit; a second low pass filter for passing only a low frequency component extracted from the mixture component; an AFT control circuit for receiving an output signal of the second low pass filter, counting a frequency difference between the standard video intermediate frequency and the received video intermediate frequency, and outputting a digital signal corresponding to the frequency difference. In the automatic frequency tuning system of the second embodiment of the present invention, even if the received video intermediate frequency is changed to a maximum extent, a difference between an oscillation frequency output from the first voltage controlled oscillator circuit and an oscillation frequency output from the second voltage controlled oscillator circuit is set so that a magnitude relationship between the oscillation frequency of the first voltage controlled oscillator circuit and the oscillation frequency of the second voltage controlled oscillator circuit is not changed.

In the automatic frequency tuning system according to a second embodiment of the present invention, the second voltage controlled oscillator circuit may have a configuration capable of outputting an oscillation frequency similar to the oscillation frequency of the first voltage controlled oscillator circuit, the automatic frequency tuning system may further comprise a second phase synchronous circuit including a first frequency divider for frequency-dividing an output signal of the second voltage controlled oscillator circuit, a second frequency divider for frequency-dividing an output signal of the highly stable frequency source externally located, a second phase detector circuit for comparing a phase of an output signal from the first frequency divider to a phase of an output signal from the second frequency divider, and a third low pass filter for smoothing an output signal of the second phase detector circuit and feeding back a signal corresponding to a second frequency control voltage to the second voltage controlled oscillator circuit, and the second frequency control voltage may be also supplied to the first voltage controlled oscillator circuit, so that a free running frequency of the first voltage controlled oscillator circuit is automatically tuned so as to be equal to the standard video intermediate frequency. In this case, “the oscillation frequency of the second voltage controlled oscillator circuit is similar to the oscillation frequency of the first voltage controlled oscillator circuit” means that the oscillation frequency of the second voltage controlled oscillator circuit is several MHz different from the oscillation frequency of the first voltage controlled oscillator circuit.

The automatic frequency tuning system of the second embodiment of the present invention may further include a local oscillator circuit for receiving an output signal from the AFT control circuit, and the local oscillator circuit may generate a high-frequency signal for frequency-converting a received signal which is a television signal received from an antenna into a standard video intermediate frequency.

### BRIEF DESCRIPTION OF THE DRAWINGS

FIG. 1 is a circuit diagram illustrating the configuration of an automatic frequency tuning system according to a first embodiment of the present invention.

FIG. 2 is a circuit diagram illustrating in detail the configuration of an AFT control circuit 36 according to the first embodiment.

FIG. 3 is a circuit diagram illustrating in detail the configuration of the AFT control circuit 36 of the first embodiment.

FIG. 4 is a table showing an example of output signals in the first embodiment.

FIG. 5 is a timing chart showing timings of signals input/output to/from main parts in circuits shown in FIGS. 2 and 3.

FIG. 6 is a graph showing two input signals of the comparator 35 in the first embodiment.

FIG. 7 is a circuit diagram illustrating an automatic frequency tuning system according to a second embodiment of the present invention.

FIG. 8 is a circuit diagram illustrating in detail the configuration of an AFT control circuit 72 according to the second embodiment.

FIG. 9 is a table showing an example of output signals in the second embodiment.

FIG. 10 is a timing chart showing timings of signals input/output to/from main parts in circuits of FIG. 8.

FIG. 11 is a circuit diagram illustrating the configuration of a known automatic frequency tuning system.

### DESCRIPTION OF THE PREFERRED EMBODIMENTS

Hereinafter, embodiments of the present invention will be described with reference to the accompanying drawings.

### First Embodiment

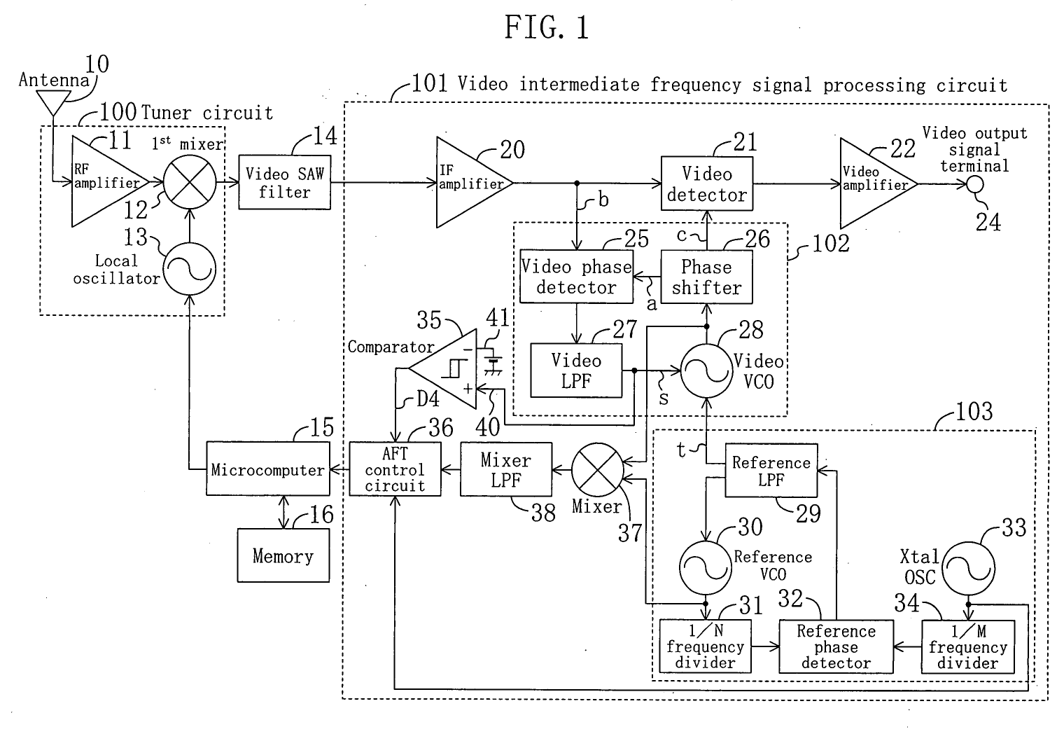

FIG. 1 is a circuit diagram illustrating the configuration of an automatic frequency tuning system according to a first embodiment of the present invention. Each of an antenna 10, a tuner circuit 100, a video SAW (surface-acoustic-wave) filter 14, a video intermediate frequency amplifier 20, a video detector 21, a video amplifier 22, a video PLL circuit 102, a microcomputer 15 and a memory 16 has a known configuration. Therefore, the detail description there of will be omitted.

In the automatic frequency tuning system of this embodiment, to reduce variation in the free-running frequency of a video voltage controlled oscillator 28, a reference PLL circuit 103 is provided.

Furthermore, in the automatic frequency tuning system of this embodiment, provided are a comparator 35 for determining a magnitude relationship between a received video intermediate frequency and a standard video intermediate frequency, a mixer 37 for-mixing an output signal of the video voltage controlled oscillator 28 and an output signal of a reference voltage controlled oscillator circuit 30 and retrieving sum and difference signals for frequencies of the output signals, a mixer low pass filter 38 for removing the sum signal and supplying only the difference signal to a subsequent stage, and an AFT control circuit 36 for receiving an output signal from the comparator 35 and an output signal from the mixer low pass filter 38 and outputting a frequency difference between the received video intermediate frequency and the standard video intermediate frequency.

Next, the operation of the automatic frequency tuning system of this embodiment will be described. First, the operation of the reference PLL circuit 103 for reducing variation in the free-running frequency of the video voltage controlled oscillator 28 will be described. The reference PLL circuit 103 generates a standard video intermediate frequency of 58.75 MHz. In the reference PLL circuit 103, to obtain an accurate reference frequency, the oscillation frequency of a crystal oscillator XtalOSC 33 is used. The oscillation frequency of the crystal oscillator XtalOSC 33 is, for example, 3.58 MHz or 4.00 MHz. Frequency accuracy in this case is several kHz, which is considered relatively high.

First, an output of the reference voltage controlled oscillator circuit 30 is frequency-divided to 1/N by a 1/N frequency divider 31 and is input to a reference phase detector 32. On the other hand, an output of the crystal oscillator XtalOSC 33 is frequency-divided to 1/M by a 1/M frequency divider 34 and is input to the reference phase detector 32. The reference phase detector 32 detects a frequency difference (phase difference) between the output of the 1/N frequency divider 31 and the output of the 1/M frequency divider 34 and outputs the detected frequency difference to the reference low pass filter 29. The output of the reference phase detector 32 is smoothed by the reference low pass filter 29 to be a frequency control voltage and is fed back to the reference voltage controlled oscillator circuit 30. By the above-described operation, the frequency of the reference voltage controlled oscillator circuit 30 becomes the standard video intermediate frequency of 58.75 MHz and the function as a PLL circuit can be achieved.

Also, an output voltage of the reference phase detector 32 which has been smoothed by the reference low pass filter 29 is supplied as a frequency control voltage t to the video voltage controlled oscillator 28 and the free-running frequency of the video voltage controlled oscillator 28 becomes the standard video intermediate frequency of 58.75 MHz. On the other hand, a frequency control voltage s corresponding to the received video intermediate frequency is supplied from the video low pass filter 27 to the video voltage controlled oscillator 28. Thus, in the video voltage controlled oscillator 28, the free-running frequency is made to be the standard video intermediate frequency of 58.75 MHz by the control voltage t and is operated so as to be synchronized with the received video intermediate frequency by the control voltage s.

In this embodiment, each of the video voltage controlled oscillator 28 and the reference voltage controlled oscillator 30 is formed in the same mask layout so as to have the same circuit configuration and include the same elements. Moreover, in the reference low pass filter 29, each of circuits for outputting frequency control voltages to the video voltage controlled oscillator 28 and the reference voltage controlled oscillator circuit 30, respectively, is formed using the same circuit configuration and the same elements.

With this configuration, the oscillation frequency of the video voltage controlled oscillator 28 is controlled by a control voltage having temperature dependency and variation dependency equal to those of the reference voltage controlled oscillator circuit 30. The oscillation frequency of the reference voltage controlled oscillator circuit 30 is made to be equal to the standard video intermediate frequency by the PLL circuit 103 and has very small temperature dependency and element variation dependency. Accordingly, change in the free-running frequency of the video voltage controlled oscillator 28 controlled by the same control voltage depending on temperature and variation in elements caused in mass production can be avoided. Thus, the frequency difference between the video voltage controlled oscillator 28 and the reference voltage controlled oscillator circuit 30 is reduced. Therefore, pull out does not occur in the video PLL circuit 102 and the video PLL circuit 102 achieves excellent characteristics.

As described above, the oscillation frequency of the crystal oscillator XtalOSC 33 differs among set manufacturers and tuner package manufacturers. For example, some manufacturers use a frequency of 3.58 MHz and others use a frequency of 4.00 MHz. Moreover, in this embodiment, the video intermediate frequency is assumed to be 58.75 MHz, which is the video intermediate frequency used in Japan. However, some other frequency may be used as the video intermediate frequency. For example, a frequency of 45.75 MHz, which is the video intermediate frequency used in the United States, may be used. An optimum value for a frequency division ratio of each of the 1/N frequency divider 31 and the 1/M frequency divider 34 is determined according to the video intermediate frequency.

Next, the automatic frequency tuning system of this embodiment will be described. First, the mixer 37 mixes an output signal of the video voltage controlled oscillator 28 which has been synchronized with a received video intermediate frequency and an output signal of the reference voltage controlled oscillator circuit 30 which oscillates precisely at the standard video intermediate frequency, and extracts sum and difference components for frequencies of the two voltage controlled oscillator circuits 28 and 30. In the mixer low pass filter 38 in the subsequent stage of the mixer 37, a filter constant is set so that a sum component of a high oscillation frequency is removed and only a difference component of a low oscillation frequency can pass through the mixer low pass filter 38. Note that the frequency difference between the two oscillators is an absolute value for the frequency difference between the video voltage controlled oscillator 28 and the reference voltage controlled oscillator circuit 30 and the magnitude relationship between a frequency output from the video voltage controlled oscillator 28 and a frequency output from the reference voltage controlled oscillator circuit 30 can not be determined in this circuit.

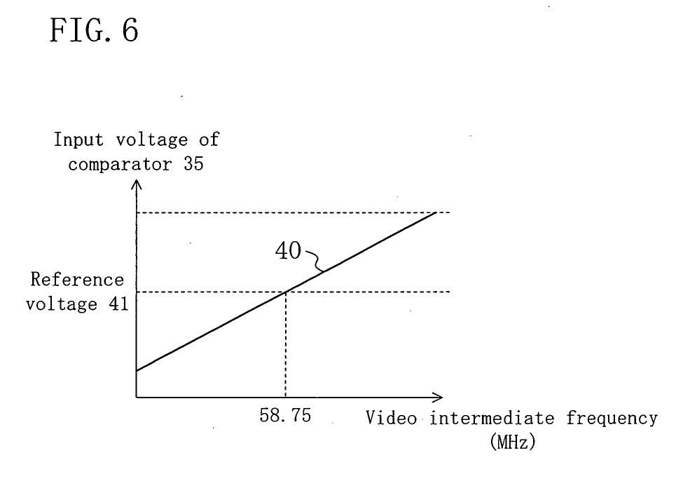

Next, an output voltage of the video low pass filter 27 operates as a control voltage of the video voltage controlled oscillator 28. Also, the output voltage of the video low pass filter 27 is input to the comparator 35 and is used for determining a magnitude relationship between the standard video intermediate frequency and a received video intermediate frequency. FIG. 6 is a graph showing two input signals of the comparator 35 in the first embodiment. As shown in FIG. 6, an output voltage 40 from the video voltage controlled oscillator 28 varies depending on the received video intermediate frequency. On the other hand, a reference voltage 41 from the video low pass filter 27 has been previously set so that the received video intermediate frequency becomes equal to the standard video intermediate frequency.

The comparator 35 is a comparator for outputting two values, i.e., “0” and “1”. For example, if the received video intermediate frequency is lower than the standard video intermediate frequency, the output voltage 40 is lower than the reference voltage 41 and the comparator 35 outputs “0”. In contrast, if the received video intermediate frequency is higher than the standard video intermediate frequency, the output voltage 40 is higher than the reference voltage 41 and the comparator 35 outputs “1”. An output voltage of the comparator 35 is provided to the digital AFT control circuit 36 in a subsequent stage. Note that in this embodiment, the case where the output voltage 40 is compared to the reference voltage 41 in the comparator 35 has been described. However, instead of the output voltages, AC signals may be compared to each other.

If the received video intermediate frequency is completely equal to the standard video intermediate frequency, an output of the comparator 35 might be instable. Therefore, it is preferable to make the comparator 35 have a hysterisis characteristic with respect to the output voltage 40 of the video voltage controlled oscillator 28 corresponding to a frequency of several kHz.

Moreover, the output voltage 40 which is an output from the video voltage controlled oscillator 28 and corresponds to a frequency of several kHz is a very small voltage, i.e., a voltage from several mV to several tens mV. Therefore, it is preferable that the comparator 35 also has functions of an amplifier.

As has been described, an absolute value for a frequency difference between an output of the video voltage controlled oscillator 28 and an output of the reference voltage controlled oscillator circuit 30 is obtained by the mixer 37 and the magnitude relationship therebetween is obtained by the comparator 35. Using these two results, the difference between the received video intermediate frequency and the standard video intermediate frequency is determined.

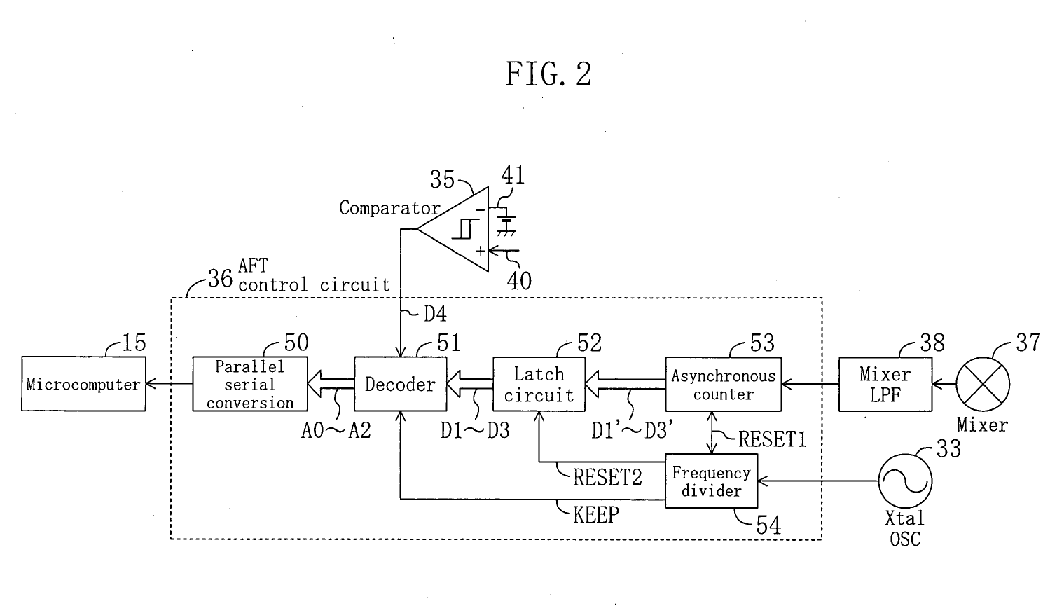

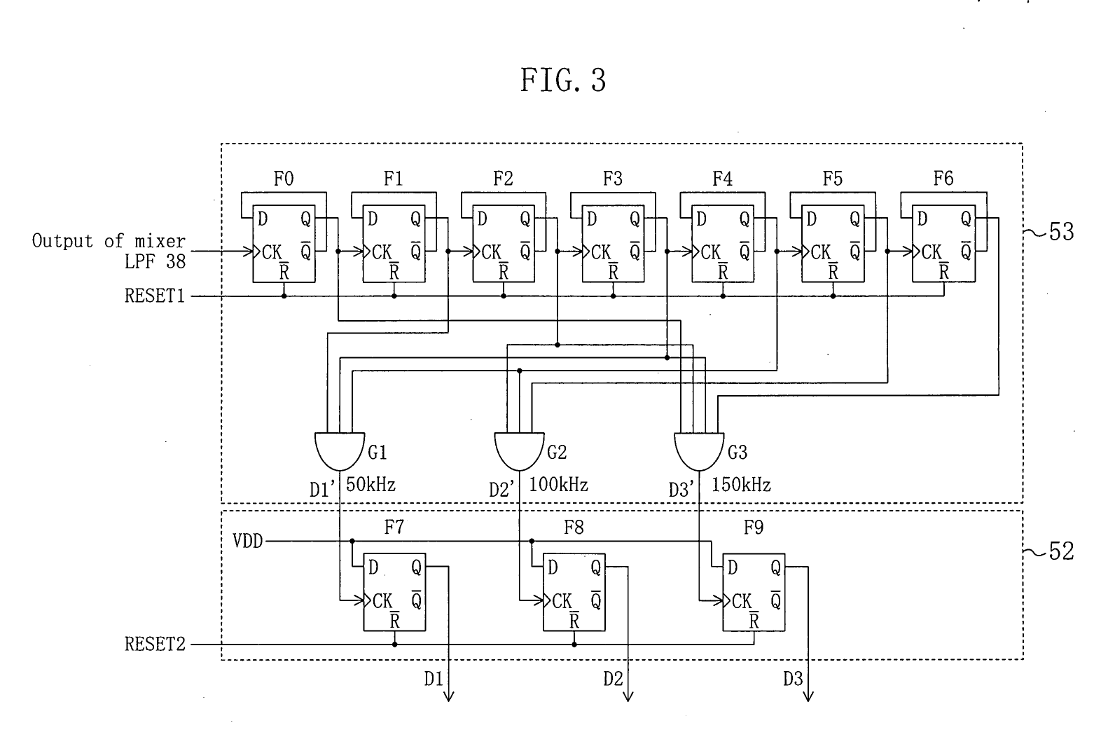

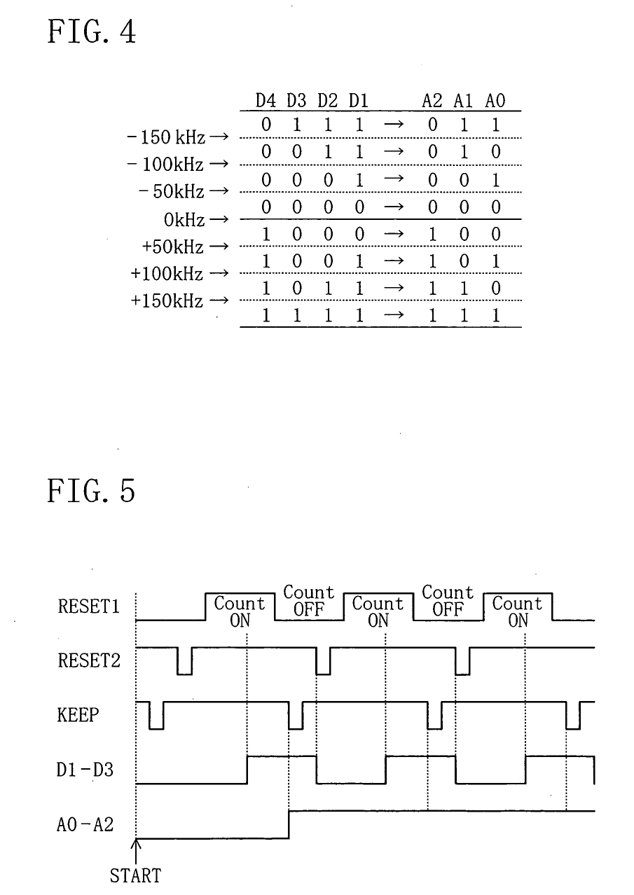

Next, the AFT control circuit 36 having the function of counting a frequency will be described. FIGS. 2 and 3 are circuit diagrams illustrating the configuration of the AFT control circuit 36 in detail. FIG. 4 is a table showing an example of output signals.

As shown in FIG. 2, the AFT control circuit 36 includes a frequency divider 54 for receiving an output from the crystal oscillator XtalOSC 33, an asynchronous counter 53 for receiving an output from the mixer low pass filter 38 and an output (RESET1) from the frequency divider 54, a latch circuit 52 for receiving outputs (D1′ through D3′) from the asynchronous counter 53 and an output (RESET2) from the frequency divider 54, a decoder 51 for receiving an output (KEEP) from the frequency divider 54 and an output (D4) from the comparator 35, and a parallel serial converter circuit 50 for receiving an output from the decoder 51.

As shown in FIG. 3, the asynchronous counter 53 includes D flip-flops F0 through F6 and gates G1 through G3. Moreover, the latch circuit 52 includes D flip-flops F7 through F9. In the circuit configuration of FIG. 3, setting is made so that the frequency of the XtalOSC 33 becomes 4.00 MHz and the output RESET1, which is a reference signal of a frequency count, is frequency-divided by 11 by the frequency divider 54. As shown in FIG. 4, thresholds for discriminating frequencies are set to be 0 kHz, ±50 kHz, ±100 kHz and ±150 kHz.

Next, the operations of the AFT control circuit 36 and the like of this embodiment will be described with reference to FIG. 5. FIG. 5 is a timing chart showing timings of signals input/output to/from main parts in circuits shown in FIGS. 2 and 3. The output signals A0 and A2 shown in FIG. 5 are input to the local oscillator 13 via the parallel serial converter circuit 50 and the microcomputer 15. The local oscillator 13 is operated so that a video intermediate frequency becomes a standard frequency. First, the frequency of XtalOSC 33 is divided by the frequency divider 54 and the signal RESET1 is output. The asynchronous counter 53 counts an output signal of the mixer 37 received via the mixer low pass filter 38 in an asynchronous manner during a period in which the signal RESET1 is “1”. As the frequency of the output of the mixer 37 is increased, the AFT control circuit 36 is operated so that the signal D1′ corresponding to 50 kHz becomes “1”, the signal D2′ corresponding to 100 kHz becomes “1” next, and finally the signal D3′ corresponding to 150 kHz becomes “1”.

Once the signals D1′, D2 and D3′ become “1”, the latch circuit 52 is operated to hold each of the signals D1′, D2 and D3′ at “1,” and outputs the signals D1′, D2′ and D3′ as signals D1, D2 and D3, respectively. Data for the signals D1′, D2′ and D3′ are held until the signal RESET2 output from the frequency divider 54 becomes “0” as shown in FIG. 5.

In the example shown in FIG. 4, the signal D4 transmitted from the comparator 35 becomes the most significant bit (MSB) and is converted together with data for D1 through D3 into desired signals A0 through A2 by the decoder 51. The signals A0 through A2 are fed back to the microcomputer 15 via the parallel serial converter circuit 50. In this case, as shown in FIG. 5, the frequency divider 54 transmits the signal KEEP to the decoder 51 in a subsequent stage before outputting the signal RESET2 for resetting the latch circuit 52 so that the signals A0 through A2 are held before the signals D1 through D3 are changed according to the video intermediate frequency.

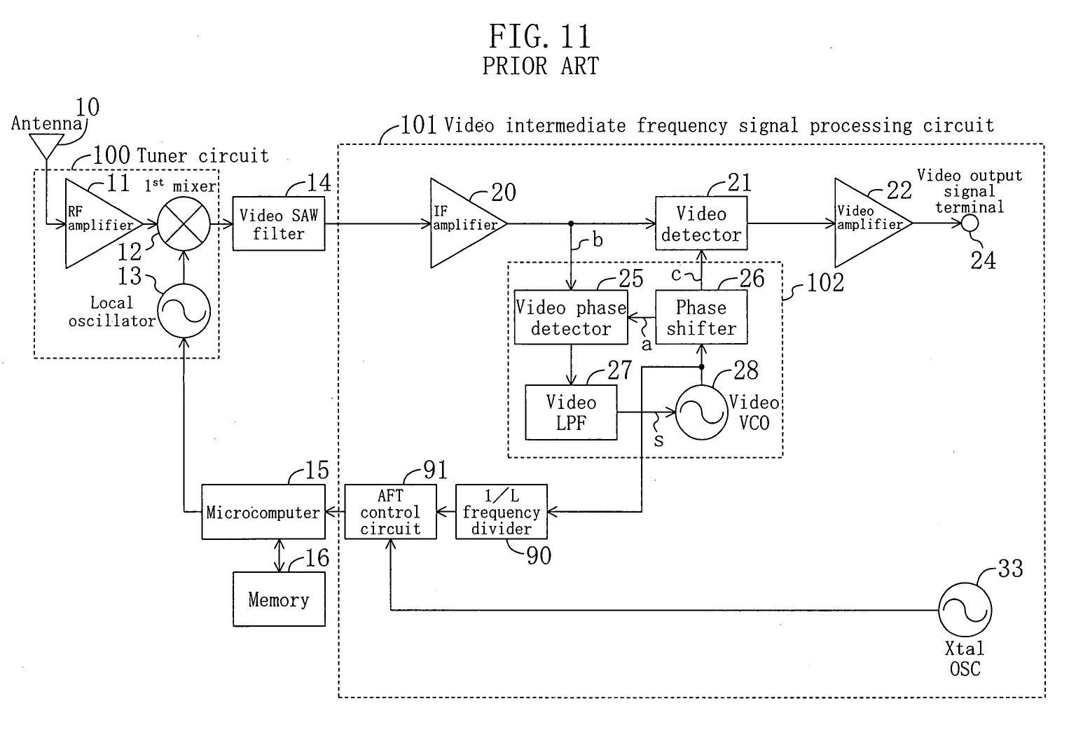

In the system of this embodiment, compared to a known system, the overall circuit size is largely reduced. Specifically, first, the size of the asynchronous counter 53 can be largely reduced. That is, in a known system, when a frequency is counted without passing through the 1/L frequency divider 90 (shown in FIG. 11), a signal of 58.75 MHz (or even when a frequency is counted via, for example, a ¼ frequency divider, a signal of 14.6875 MHz, i.e., 58.75 MHz/4) is frequency-counted. In contrast, according to the present invention, it is sufficient to frequency-count a signal of several 100 kHz at highest. Thus, the number of the flip-flops F0 through F6 each having the function of dividing a frequency to ½ can be largely reduced. Specifically, although in a known circuit, about 15 flip-flops are necessary, according to the present invention, the number of required flip-flops is about 7. That is, the number of flip-flops is reduced by about 8 flip-flops (58.75 MHz/50 kHz=392>2⁸), so that the size of a circuit is reduced to half of the size of the known circuit.

Moreover, the sizes of the gate circuits G1 through G3 can be reduced. The gate circuits G1 through G3 count desired frequencies and output the signals D1′, D2′ and D3′, respectively. In the known circuit, a frequency input to each of the gate circuits G1 through G3 is about 58.75 MHz±150 kHz. Therefore, to count a desired frequency with a resolution of about 10 kHz, the number of flip-flops F0 through F6 having the frequency-dividing function is increased and the number of input ports per a single gate circuit is also increased, so that the circuit size of each gate circuit is increased. However, according to the present invention, a frequency to be counted is about 150 kHz, the number of input ports per a single gate circuit is reduced, so that the size of a gate circuit is reduced. Specifically, in the known circuit, the number of input ports of gate circuits is equal to the number of flip-flops, i.e., about 15. In contrast, according to the present invention, the number of input ports is about 7 at most, and as the number of input ports in each gate circuit is reduced, a circuit size is reduced. Moreover, in a known example, a received video intermediate frequency has two polarities, i.e., a larger polarity and a smaller polarity than the standard video intermediate frequency and thus the two polarities have to be counted. However, according to the present invention, a judgment signal for judging whether the polarity is the larger polarity or the smaller polarity is transmitted from the comparator 35 and only an absolute value for a frequency difference has to be counted. Thus, the number of the gates G1 through G3 is reduced to half. Specifically, in the known circuit, seven frequencies, i.e., 0 kHz, ±50 kHz, ±100 kHz and ±150 kHz in all are counted. However, according to the present invention, only four absolute values, i.e., 0 kHz, 50 kHz, 100 kHz and 150 kHz are counted, so that the number of gates is reduced to about half.

That is, as the number of flip-flops is reduced to half, the number of input ports per a single gate circuit is reduced. Moreover, only an absolute value of a frequency difference has to be counted and therefore the number of gate circuits is also reduced. Therefore, the size of a gate circuit as a whole is reduced to ¼.

Furthermore, as the number of output signals (D1′ through D3′) of the asynchronous counter 53 is reduced to half, the circuit size of the latch circuit 52 is also reduced to half.

Furthermore, in the decoder 51, because a polarity is transmitted from the comparator 35, bits to be decoded is reduced by 1. Accordingly, the circuit size of the decoder 51 is also reduced.

According to this embodiment, as a result of reduction in the circuit size of each member in the above-described manner, the overall circuit size can be reduced to about ¼ of that of the known system (i.e., 75% reduction in circuit size is allowed). That is, according to this embodiment, a circuit size can be largely reduced without reducing a frequency resolution at all, and thus an automatic frequency tuning system which allows both of improvement of performance and reduction in cost can be provided.

Because the video intermediate frequency is 58.75 MHz in Japan, in the present invention, the description has been made on the assumption that each of the oscillation frequency of the video voltage controlled oscillator 28 and the oscillation frequency of the reference voltage controlled oscillator circuit 30 is set to be 58.75 MHz. Needless to say, for example, in the United States, the video intermediate frequency is 45.75 MHz, and in this case, each of the oscillation frequency of the video voltage controlled oscillator 28 and the oscillation frequency of the reference voltage controlled oscillator circuit 30 is set to be also 45.75 MHz.

### Second Embodiment

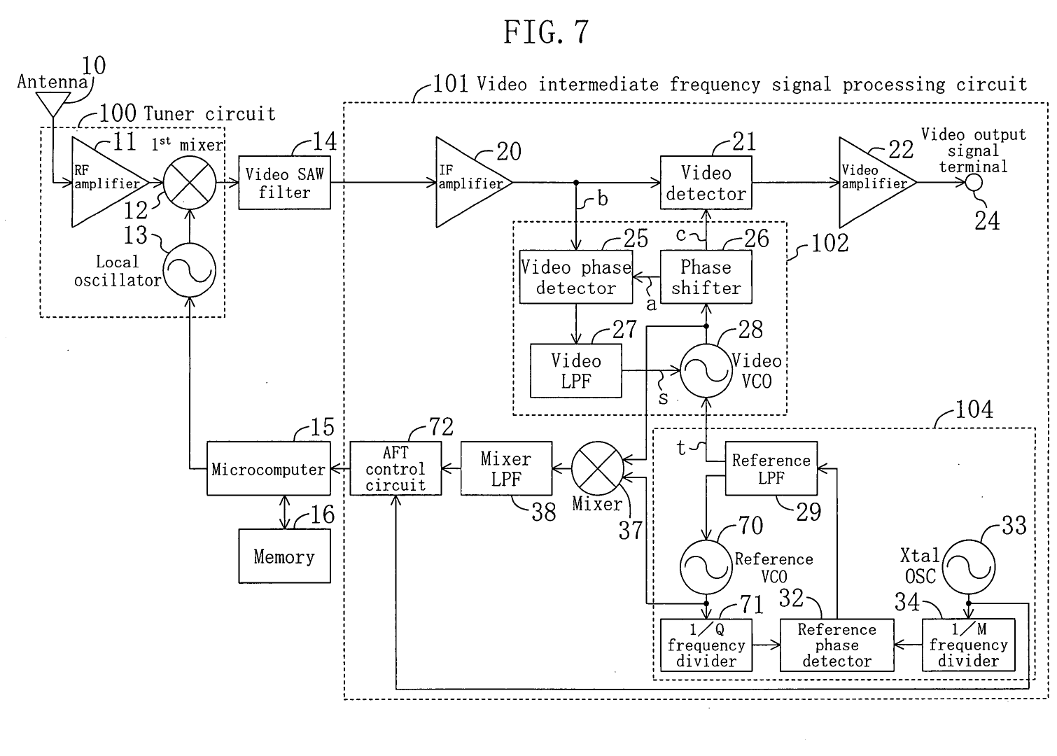

FIG. 7 is a circuit diagram illustrating an automatic frequency tuning system according to a second embodiment of the present invention. Each of an antenna 10, a tuner circuit 100, a video SAW filter 14, a video intermediate frequency amplifier 20, a video detector 21, a video amplifier 22, a video PLL circuit 102, a microcomputer 15 and a memory 16 according to this embodiment has a known configuration. Therefore, the detail description thereof will be omitted.

In the automatic frequency tuning system of this embodiment, to reduce variation in the free running frequency of a video voltage controlled oscillator 28, a reference PLL circuit 104 configured in the same manner as in the first embodiment is provided. In the first embodiment, the oscillation frequencies of the video voltage controlled oscillator 28 and the reference voltage controlled oscillator circuit 30 are set to be substantially the same. However, in the second embodiment, the oscillation frequencies of a video voltage controlled oscillator 28 and a reference voltage controlled oscillator circuit 30 are set to be different from each other.

In the automatic frequency tuning system of this embodiment, provided are a mixer 37 for mixing an output signal of the video voltage controlled oscillator 28 and an output signal of a reference voltage controlled oscillator circuit 70 and retrieving sum and difference signals for frequencies of the output signals, a mixer low pass filter 38 for removing the sum signal and supplying only the difference signal to a subsequent stage, an AFT control circuit 72 for outputting a frequency difference between a video intermediate frequency received from the mixer low pass filter 38 and a standard video intermediate frequency. In the first embodiment, the comparator 35 for determining a magnitude relationship between a received video intermediate frequency and a standard video intermediate frequency is provided. In the second embodiment, however, the comparator 35 is not provided.

Next, the automatic frequency tuning system of this embodiment will be described. Except for the reference PLL circuit 104, the automatic frequency tuning system of this embodiment has the same configuration and function as those of a known automatic frequency tuning system.

First, the operation of the reference PLL circuit 104 for reducing variation in the free running frequency of the video voltage controlled oscillator 28 will be described. In the reference PLL circuit 104, a reference oscillation frequency which is several MHz different from the standard video intermediated frequency of 58.75 MHz is generated. In the reference PLL circuit 104, to obtain an accurate reference frequency, the oscillation frequency of a crystal oscillator XtalOSC 33 is used. The oscillation frequency of the crystal oscillator XtalOSC 33 is, for example, 3.58 MHz or 4.00 MHz. Frequency accuracy in this case is several kHz, which is considered relatively high.

An output of the reference voltage controlled oscillator circuit 70 is frequency-divided to 1/Q by a 1/Q frequency divider 71 and is input to the reference phase detector 32. On the other hand, an output of the crystal oscillator XtalOSC 33 is frequency-divided to 1/M by the 1/M frequency divider 34 and input to the reference phase detector 32. In the reference phase detector 32, a frequency difference (phase difference) between the two inputs is detected and an output of the reference phase detector 32 is smoothed by a reference low pass filter 29 to be a frequency control voltage. The frequency control voltage is fed back to the frequency voltage controlled oscillator circuit 70. By the above-described operation, the frequency of the reference voltage controlled oscillator circuit 70 becomes a reference oscillation frequency which is several MHz different from the standard video intermediate frequency 58.75 MHz and the function as a PLL circuit can be achieved.

Also, an output voltage of the frequency phase detector 32 which has been smoothed by the reference low pass filter 29 is supplied to the video voltage controlled oscillator 28 as a frequency control voltage v obtained in taking the oscillation frequency difference between the reference voltage controlled oscillator circuit 70 and the video voltage controlled oscillator 28, so that the free running frequency of the video voltage controlled oscillator 28 becomes the standard video intermediate frequency of 58.75 MHz. On the other hand, a frequency control voltage s corresponding to the received video intermediate frequency is supplied from the video band pass filter 27 to the video voltage controlled oscillator 28. Thus, in the video voltage controlled oscillator 28, the free running frequency is made to be the standard video intermediate frequency of 58.75 MHz by the control voltage t, and is operated by the control voltage s so as to be synchronized with the received video intermediate frequency.

In this embodiment, each of the video voltage controlled oscillator 28 and the reference voltage controlled oscillator circuit 70 is formed in the same mask layout so as to have the same circuit configuration and include the same elements. Moreover, in the reference low pass filter 29, each of circuits for outputting frequency control voltages to the video voltage controlled oscillator 28 and the reference voltage controlled oscillator circuit 70, respectively, is formed using the same circuit configuration and the same elements. Note that control voltages for controlling the oscillators, respectively, have to be the same voltage level and the respective oscillation frequencies of the oscillators have to be different from each other. Therefore, if multi-vibrator oscillators are used for the oscillators, a capacitance value of a load is changed or like adjustment is made. However, only minimum necessary adjustment is to be made and therefore the configuration of a resultant circuit is very similar to the above-described configuration.

With the above-described configuration, the oscillation frequency of the video voltage controlled oscillator 28 is controlled by a control voltage having temperature dependency and variation dependency equal to those of the oscillation frequency of the reference voltage controlled oscillator circuit 70. The oscillation frequency of the reference voltage controlled oscillator circuit 70 is made to be equal to a reference frequency by the PLL circuit and thus has very small temperature dependency and element variation dependency. Accordingly, change in the free-running frequency of the video voltage controlled oscillator 28 controlled by the same control voltage according to temperature and variation in elements caused in mass production can be avoided. Therefore, pull out does not occur in the video PLL circuit 102 and the video PLL circuit 102 achieves excellent characteristics.

As described above, the oscillation frequency of the crystal oscillator XtalOSC 33 differs among set manufacturers and tuner package manufacturers. For example, some manufacturers use a frequency of 3.58 MHz and others use a frequency of 4.00 MHz. Moreover, in this embodiment, the video intermediate frequency is assumed to be 58.75 MHz, which is the video intermediate frequency used in Japan. However, some other frequency may be used as the video intermediate frequency. For example, a frequency of 45.75 MHz, which is the video intermediate frequency used in the United States, may be used. An optimum value for a frequency division ration of each of the 1/N frequency divider 31 and the 1/M frequency divider 34 is determined according to the video intermediate frequency.

Next, the automatic frequency tuning system of this embodiment will be described. First, the mixer 37 mixes an output signal of the video voltage controlled oscillator 28 which has been synchronized with a received video intermediate frequency and an output signal of the reference voltage controlled oscillator circuit 70 which oscillates precisely at the reference frequency, and extracts sum and difference components for frequencies of the two voltage controlled oscillator circuits. In the mixer low pass filter 38 in a subsequent stage of the mixer 37, a filter constant is set so that the sum component is removed and only the difference component can pass through the mixer low pass filter 38. The frequency difference between the two oscillators is set to be large, i.e., several MHz. Thus, a magnitude relationship between a frequency output from the video voltage controlled oscillator 28 and a frequency output from the reference voltage controlled oscillator circuit 70 is determined without depending on the received video intermediate frequency. That is, the magnitude relationship between frequencies does not have to be determined in this embodiment.

As described above, the frequency difference between the video voltage controlled oscillator 28 and the reference voltage controlled oscillator circuit 70 is obtained by an output signal only from the mixer 37. That is, a difference between a received video intermediate frequency and a reference frequency is determined.

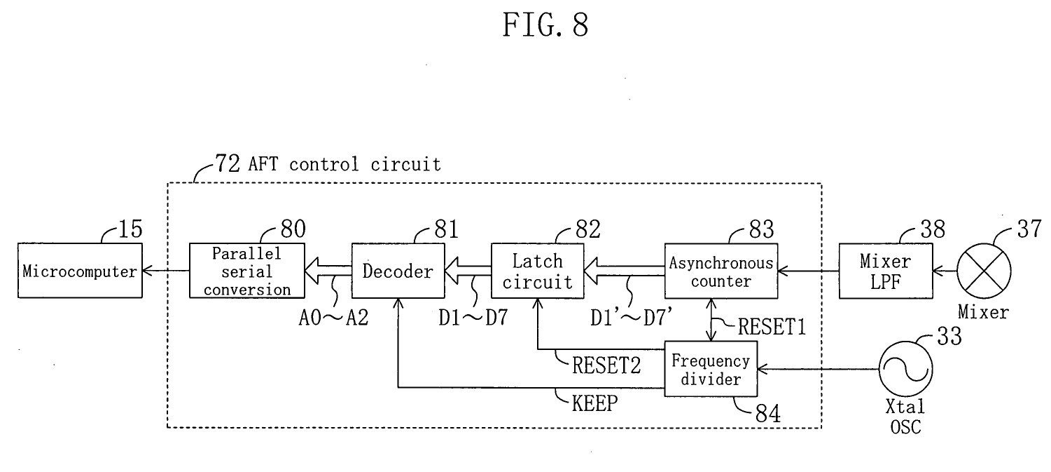

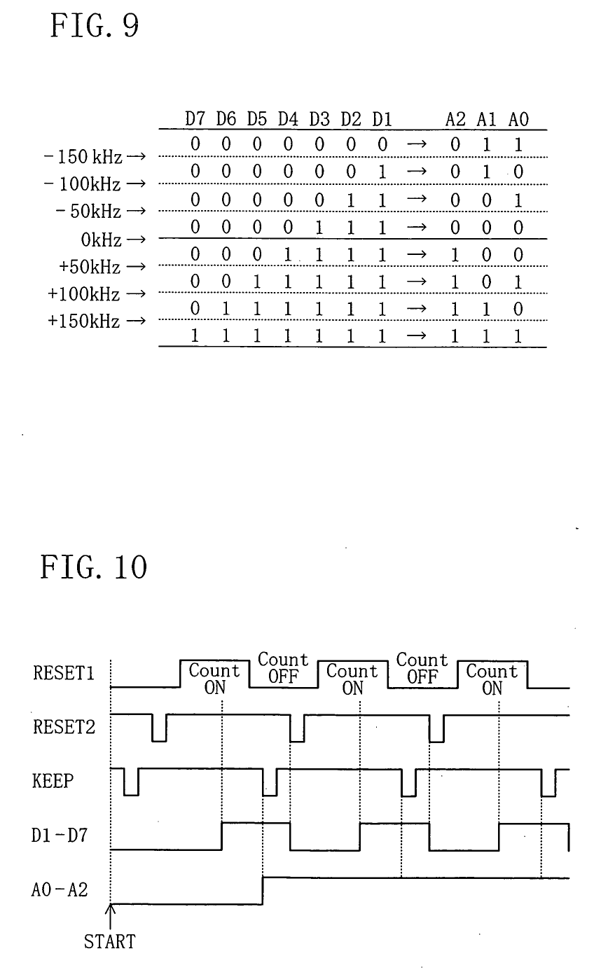

Next, the AFT control circuit 72 having the function of counting a frequency will be described. FIG. 8 is a circuit diagram illustrating the configuration of the AFT control circuit 72 in detail. FIG. 9 is a table showing an example of output signals. FIG. 10 is a timing chart showing timings of signals input/output to/from main parts in circuits shown in FIG. 8. The output signals A0 and A2 shown in FIG. 10 are input to a local oscillator 13 via a parallel serial converter circuit 80 and a microcomputer 15. The local oscillator 13 is operated so that the video intermediate frequency becomes a standard frequency. The local oscillator 13 generates a high-frequency signal for converting the frequency of a received signal, i.e., a television signal received via an antenna into a video intermediate frequency.

In FIG. 8, the detail configuration of the AFT control circuit 72 is shown. Specifically, the AFT control circuit 72 includes a frequency divider 84 for receiving an output from the crystal oscillator XtalOSC 33, an asynchronous counter 83 for receiving an output from the mixer low pass filter 38 and an output (RESET1) from the frequency divider 84, a latch circuit 82 for receiving outputs (D1′ through D7′) from the asynchronous counter 83 and an output (RESET2) from the frequency divider 84, a decoder 81 for receiving an output (KEEP) from the frequency divider 84, and a parallel serial converter circuit 80 for receiving an output from the decoder 81.

Note that although not shown in the drawings, as in the first embodiment, the asynchronous counter 83 includes D flip-flops and gates and the latch circuit 82 includes D flip-flops.

Next, the operations of the AFT control circuit and the like of this embodiment will be described with reference to FIG. 9. First, the frequency of XtalOSC 33 is divided by the frequency divider 84 and the signal RESET1 is output. The asynchronous counter 83 counts an output signal of the mixer 37 received via the mixer low pass filter 38 in an asynchronous manner during a period in which the signal RESET1 is “1”. As the frequency of the output of the mixer 37 is increased, the AFT control circuit is operated so that the signal D1′ corresponding to −150 kHz becomes “1”, the signal D2′ corresponding to −100 kHz becomes “1” next, the D3′, D4′ and D5′ and D6′ become “1” in this order, and finally the signal D7′ corresponding to +150 kHz becomes “1”.

Once the signals D1′ through D7′ become “1”, the latch circuit 82 is operated to hold each of the signals D1′ through D7′ at “1” and outputs the signals D1′ through D7′ as signals D1 through D7, respectively. Data for the signals D1′ through D7′ are held until the signal RESET2 output from the frequency divider 84 becomes “0” as shown in FIG. 10.

Next, data for D1 through D7 are converted into desired signals A0 though A2 by the decoder 81 and then are fed back to the microcomputer 15 via the parallel serial converter circuit 80. In this case, as shown in FIG. 10, the frequency divider 84 transmits the signal KEEP to the decoder 81 in a subsequent stage before outputting the signal RESET2 for resetting the latch circuit 82, so that the signals A0 through A2 are held before the signals D1 through D7 are changed according to the video intermediate frequency.

In the system of this embodiment, compared to a known system, the overall circuit size is largely reduced. Specifically, first, the size of the asynchronous counter 83 can be largely reduced. That is, in the known system, when a frequency is counted without passing through the 1/L frequency divider 90 (shown in FIG. 11), a signal of 58.75 MHz (or even when a frequency is counted via, for example, a ¼ frequency divider, a signal of 14.6875 MHz, i.e., 58.75 MHz/4) is frequency-counted. In contrast, according to the present invention, it is sufficient to frequency-count a signal of several 100 kHz at highest. Thus, the number of the flip-flops can be largely reduced. Specifically, although in a known circuit, about 15 flip-flops are required, according to the present invention, the number of required flip-flops is about 10. That is, the number of flip-flops is reduced by about 5 flip-flops (58.75 MHz/several kHz>2⁵), so that the size of a circuit is reduced by about 30%.

Moreover, the sizes of gate circuits in the asynchronous counter 83 can be reduced. The gate circuits count desired frequencies and output the signals D1′ through D7′. In the known system, a frequency input to each of the gate circuits is about 58.75 MHz ±150 kHz. Therefore, to count a desired frequency with a resolution of about 10 kHz, the number of flip-flops is increased and the number of input ports per a single gate circuit is also increased, so that the circuit size of each gate circuit is increased. However, according to the present invention, a frequency to be counted is about 150 kHz, the number of input ports per a single gate circuit is reduced, so that the size of a gate circuit is reduced. Specifically, in the known circuit, the number of input ports in a gate circuit is equal to the number of flip-flops, i.e., about 15. In contrast, according to the present invention, the number of input ports is about 10 at most, and as the number of input ports in each gate circuit is reduced, a circuit size is reduced.

Furthermore, as the number of output signals (from D1′ to D7′) is reduced by 30%, the circuit size of the latch circuit 82 is reduced by 30%.

As described above, in this embodiment, as a result of reduction in circuit size, a circuit size can be reduced by about 30%, compared to the known system. That is, a circuit size can be largely reduced without reducing a frequency resolution at all. Thus, an automatic frequency tuning system which allows both of improvement of performance and reduction in cost can be provided.

Because the video intermediate frequency is 58.75 MHz in Japan, in the present invention, the description has been made on the assumption that each of the oscillation frequency of the video voltage controlled oscillator 28 and the oscillation frequency of the reference voltage controlled oscillator circuit 70 is a frequency close to 58.75 MHz. Needless to say, for example, in the United States, the video intermediate frequency is 45.75 MHz, and thus each of the oscillation frequency of the video voltage controlled oscillator 28 and the oscillation frequency of the reference voltage controlled oscillator circuit 70 is also a frequency close to 45.75 MHz.

What is claimed is:

1. An automatic frequency tuning system comprising:
a first phase synchronous circuit including a first voltage controlled oscillator circuit, a first phase detector circuit for comparing a phase of an output signal of the first voltage controlled oscillator circuit to a phase of a received video intermediate frequency signal, and a first low pass filter for smoothing an output of the phase detector circuit and feeding back a first frequency control voltage to the first voltage controlled oscillator circuit;
a second voltage controlled oscillator circuit synchronized with a frequency received from a highly stable frequency source externally located and oscillating at a standard video intermediate frequency;
a mixer for outputting a mixture component obtained by mixing a frequency output from the first voltage controlled oscillator circuit and a frequency output from the second voltage controlled oscillator circuit;
a second low pass filter for passing only a low frequency component extracted from the mixture component;
a comparator for determining a magnitude relationship between the received video intermediate frequency which is an oscillation frequency of the first voltage controlled oscillator circuit and the standard video intermediate frequency; and
an AFT control circuit for receiving an output signal of the comparator and an output signal of the second low pass filter, counting a frequency difference between the standard video intermediate frequency and the received video intermediate frequency, determining a polarity of the received video intermediate frequency based on the output signal of the comparator, and outputting a digital signal corresponding to the frequency difference.

2. The automatic frequency tuning system of claim 1, wherein the oscillation frequency of the first control oscillator circuit and an oscillation frequency of the second voltage controlled oscillator circuit are set to be substantially the same.

3. The automatic frequency tuning system of claim 1, wherein the first frequency control voltage is proportional to the received video intermediate frequency, and wherein the comparator compares the first frequency control voltage to a reference voltage which has been previously set, thereby determining a magnitude relationship between the received video intermediate frequency and the standard video intermediate frequency.

4. The automatic frequency tuning system of claim 3, wherein the reference voltage in the comparator is previously set so as to be equal to the first frequency control voltage obtained when the received video intermediate frequency is the standard video intermediate frequency.

5. The automatic frequency tuning system of claim 3, wherein the comparator has a hysteresis characteristic with respect to the first frequency control voltage.

6. The automatic frequency tuning system of claim 1, wherein the second voltage controlled oscillator circuit has substantially the same configuration as a configuration of
the first voltage controlled oscillator, wherein the automatic frequency tuning system further comprises a second phase synchronous circuit including
a first frequency divider for frequency-dividing an output signal of the second voltage controlled oscillator circuit,
a second frequency divider for frequency-dividing an output signal of the highly stable frequency source externally located,
a second phase detector circuit for comparing a phase of an output signal from the first frequency divider to a phase of an output signal from the second frequency divider, and
a third low pass filter for smoothing an output signal of the second phase detector circuit and feeding back a signal corresponding to a second frequency control voltage to the second voltage controlled oscillator circuit, and
wherein the second frequency control voltage is also supplied to the first voltage controlled oscillator circuit, so that a free running frequency of the first voltage controlled oscillator circuit is automatically tuned so as to be equal to the standard video intermediate frequency.

7. The automatic frequency tuning system of claim 1, further comprising a local oscillator circuit for receiving an output signal from the AFT control circuit, wherein the local oscillator circuit generates a high-frequency signal for frequency-converting a received signal which is a television signal received from an antenna into a standard video intermediate frequency.

8. An automatic frequency tuning system comprising:
a first phase synchronous circuit including a first voltage controlled oscillator circuit, a first phase detector circuit for comparing a phase of an output signal of the first voltage controlled oscillator circuit to a phase of a received video intermediate frequency signal, and a first low pass filter for smoothing an output of the phase detector circuit and feeding back a first frequency control voltage to the first voltage controlled oscillator circuit;
a second voltage controlled oscillator circuit synchronized with a frequency received from a highly stable frequency source externally located and oscillating at a standard video intermediate frequency;
a mixer for outputting a mixture component obtained by mixing a frequency output from the first voltage controlled oscillator circuit and a frequency output from the second voltage controlled oscillator circuit;
a second low pass filter for passing only a low frequency component extracted from the mixture component;
an AFT control circuit for receiving an output signal of the second low pass filter, counting a frequency difference between a standard video intermediate frequency and the received video intermediate frequency, and outputting a digital signal corresponding to the frequency difference,
wherein even if the received video intermediate frequency is changed to a maximum extent, a difference between an oscillation frequency output from the first voltage controlled oscillator circuit and an oscillation frequency output from the second voltage controlled oscillator circuit is set so that a magnitude relationship between the oscillation frequency of the first voltage controlled oscillator circuit and the oscillation frequency of the second voltage controlled oscillator circuit is not changed.

9. The automatic frequency tuning system of claim 8, wherein the second voltage controlled oscillator circuit has a configuration capable of outputting an oscillation frequency similar to the oscillation frequency of the first voltage controlled oscillator circuit,
wherein the automatic frequency tuning system further comprises a second phase synchronous circuit including
a first frequency divider for frequency-dividing an output signal of the second voltage controlled oscillator circuit,
a second frequency divider for frequency-dividing an output signal of the highly stable frequency source externally located,
a second phase detector circuit for comparing a phase of an output signal from the first frequency divider to a phase of an output signal from the second frequency divider, and
a third low pass filter for smoothing an output signal of the second phase detector circuit and feeding back a signal corresponding to a second frequency control voltage to the second voltage controlled oscillator circuit, and
wherein the second frequency control voltage is also supplied to the first voltage controlled oscillator circuit, so that a free running frequency of the first voltage controlled oscillator circuit is automatically tuned so as to be equal to the standard video intermediate frequency.

10. The automatic frequency tuning system of claim 8, further comprising a local oscillator circuit for receiving an output signal from the AFT control circuit,
wherein the local oscillator circuit generates a high-frequency signal for frequency-converting a received signal which is a television signal received from an antenna into a standard video intermediate frequency.
